(19) United States
(12) Patent Application Publication
(10) Pub. No.: US 2022/0361411 A1
(43) Pub. Date: Nov. 17, 2022

(54) COMBINE HARVESTER WITH A WEED SEED DESTRUCTION DEVICE FEEDING TO A STRAW SPREADER

(71) Applicant: Tritana Intellectual Property Ltd., Saskatoon (CA)

(72) Inventors: Dean Mayerle, Saskatoon (CA); Justin Regier, Aberdeen (CA)

(21) Appl. No.: 17/741,878

(22) Filed: May 11, 2022

Related U.S. Application Data
(60) Provisional application No. 63/188,153, filed on May 13, 2021.

(51) Int. Cl. A01F 12/40; A01D 41/12

(52) U.S. Cl. CPC A01F 12/40; A01D 41/1243

(57) ABSTRACT

A combine harvester includes a straw chopper, spreading device and a weed seed destructor (WSD) which acts on the weed seeds in the chaff so as to cause devitalization. The WSD includes a discharge mouth where the WSD causes generation of an air flow which exits through the mouth. The system is operable in two modes where in both the straw is directed to the straw spreading device. In the first mode the chaff is directed into the WSD and in the second mode the chaff is carried past the WSD on a guide surface and is converged inwardly to drop into the air stream from the WSD. In both modes the chaff is spread using the air stream from the WSD at least to the sides either by feeding to the spreading device or by combining with the stream of straw after it leaves the spreading device.

This application claims the benefit under 35 USC 119 (e) of Provisional Application 63/188153 filed May 13 2021, the disclosure of which is incorporated herein by reference.

This invention relates to a combine harvester with a weed seed destructor (WSD) and straw spreader arranged so that weed seeds in the discharged chaff can be devitalized before being spread onto the ground by the straw spreader. In particular the present invention provides a guide system which allows weed seeds and chaff to bypass the weed seed destructor when not required while still being spread to the sides.

### BACKGROUND OF THE INVENTION

In U.S. Pat. No. 10,004,176 issued Jun. 26, 2018 U.S. Pat. No. 10,485,178 issued Nov. 26, 2019, U.S. Pat. No. 10,495,369 issued Dec. 3, 2019 and PCT is Publication 2019/046973 published Mar. 14 2019 there is disclosed an arrangement in which weed seeds are destroyed in the chaff from a combine harvester by a rotary mill causing repeated high speed impacts by a rotor mounted in one of a pair of side by side housings which accelerate the discarded seeds in a direction centrifugally away from the rotor onto a stator including a series of coaxial and radially spaced zo stator surfaces around the axis. Thus the discarded seeds rebound back and forth between the rotor and the stator to provide a plurality of impacts.

Also in co-pending U.S. application Ser. No. 16/574,384 filed Sep. 18 2019 which corresponds to PCT application PCT/CA2019/051320 publication WO2020/069602 published 9 Apr. 2020 there is disclosed an improved arrangement of stator for use in the above arrangements.

A further improvement is shown in US published application US2020/0107502 published Apr. 9 2020 by the present applicant which shows an arrangement of stator bars which are shaped to provide an improved impact action on the seeds.

Combine mounted weed seed destruction units are becoming a common tool for destroying weeds retained in the crop while harvesting. Most of these weed seed control units are capable of devitalizing the weeds found in the chaff of a combine harvester. Research has shown that with three consecutive cycles of weed and grain removal, significant reductions in herbicide can be obtained meaning huge saving for farmers.

Weed seed destruction initially was developed in Australia due to the widespread problem of herbicide resistance weeds in the country. As this problem has developed in other areas of the world the technology must be adapted for use with the harvest systems and conditions employed in these new areas. Often these countries have much more difficult harvest conditions than the Australians as the Australian harvest starts in their spring and progresses into the heat of their summer. The Australian harvest starts with tough and greener crops and progresses to dry and brittle harvest conditions. Most cropping regions in the northern hemisphere start with tough and green crops as the plant's complete maturity, then progress to dryer conditions until a rain or snow event stops harvest, starting again with tough crop harvesting conditions.

A construction of straw chopper which can be used herein is shown in U.S. Pat. No. 6,840,854 issued Jan. 11, 2005 of Redekop.

It is known also from published US applications 2020/0120917 published Apr. 23, 2020 and 2022/0008889 published Jan. 13 2022 of Jackson that weed seeds can be devitalized by application of light. In these arrangements the chaff and seeds can be carried by a conveyor through an area of illumination to cause the required devitalization.

The disclosures of each of the above cited documents are incorporated herein by reference.

The term weed seed destruction used herein is used somewhat colloquially in that the seeds are not annihilated but are devitalized or rendered so that is they cannot germinate. It will of course also be appreciated that not necessarily each and every seed is destroyed but that the intention is that a significant number will be incapable of germination so as to reduce the number of emerging seeds in the next growing season. Many different modalities for causing this devitalization are possible including grinding, crushing, impacting, radiation and chemical systems.

One of the primary requirements of a residue management system on a combine harvester is to distribute the harvest residue including the chaff from the sieves and the straw from the rotor or straw walkers back over a combine's entire cutting width. In many cases, the chaff is incorporated back into the straw and processed through a straw chopper and then spread over the field by a spreading system which receives the straw from the chopper. The spreading system can be a tailboard with fins which uses the air flow from the chopper to spread the material. Alternatively the spreading system can be powered with various designs being used by different manufacturers.

It is known in some cases that it is desirable to halt operation of the WSD when not required or when not desirable while continuing to operate the spreading of the straw. In this situation, it is common to discharge the chaff into the straw stream in the chopper/spreader to be spread with the straw.

### SUMMARY OF THE INVENTION

According to the invention there is provided a combine harvester comprising:

a separation system for separating from harvested crop a first material comprising straw and a second material comprising chaff and weed seeds;

a straw spreading device for receiving the first material and spreading the first material at least to the sides of the combine harvester;

a weed seed destructor section arranged to receive the second material;

the weed seed destructor section having one or more components acting on the weed seeds in the second material so as to cause devitalization of at least some of the weed seeds so that they cannot germinate;

the weed seed destructor section having at least one discharge mouth for discharge of the second material after said devitalization;

wherein the weed seed destructor section causes generation of an air flow which exits through said at least one discharge mouth;

the weed seed destructor section and the straw spreading device being operable in a first arrangement in which:
the first material is directed to the straw spreading device for spreading the first material at least to the sides of the combine harvester;
and the second material is directed into the weed seed destructor section and at least some of the discharge from said at least one discharge mouth is spread in said airflow at least to the sides of the combine harvester;

the weed seed destructor section and the straw spreading device being operable in a second arrangement in which:
the first material is directed to the straw spreading device for spreading the first material at least to the sides of the combine harvester;
and the second material by-passes the weed seed destructor section and at least some of the second material by-passing the weed seed destructor section is spread at least to the sides of the combine harvester;

wherein the air flow from said at least one discharge mouth is used in the second arrangement to carry said second material for spreading at least to the sides of the combine harvester.

In one embodiment, in the second arrangement, the air flow through said at least one discharge mouth is used to transfer said second material to said straw spreading device.

In one embodiment, in the second arrangement, the air flow through said at least one discharge mouth is used to spread the second material at least to the sides of the combine harvester.

In one embodiment, in the second arrangement, the air flow through said at least one discharge mouth is used to carry the second material for combining with the first material as it is spread at least to the sides of the combine harvester by the straw spreading device.

In one embodiment, there is provided a straw chopper having a housing containing a rotor into which the first material is fed before passing to the straw spreading device where, in both the first and second arrangements, the second material bypasses the straw chopper.

In accordance with a second aspect of the invention there is provided a combine harvester comprising:

a separation system for separating from harvested crop a first material comprising straw and a second material comprising chaff and weed seeds;

a straw chopping device for receiving and chopping the first material and a straw spreading device for receiving the chopped first material and spreading the first material at least to the sides of the combine harvester;

a weed seed destructor section arranged to receive the second material;

the weed seed destructor section having one or more components acting on the weed seeds in the second material so as to cause devitalization of at least some of the weed seeds so that they cannot germinate;

the weed seed destructor section having at least one discharge outlet for discharge of the second material after said devitalization;

the weed seed destructor section and the straw spreading device being operable in a first arrangement in which:
the first material is directed to the straw spreading device for spreading the first material in a discharge stream at least to the sides of the combine harvester;
and the second material is directed into the weed seed destructor section and at least some of the discharge from said at least one discharge mouth is spread in a discharge stream at least to the sides of the combine harvester;

the weed seed destructor section and the straw spreading device being operable in a second arrangement in which:
the first material is directed to the straw spreading device for spreading the first material in a discharge stream at least to the sides of the combine harvester;
and the second material by-passes the weed seed destructor section and at least some of the second material by-passing the weed seed destructor section is spread in a discharge stream at least to the sides of the combine harvester;

wherein, in both the first and second arrangements, the second material bypasses the straw chopper.

Thus, in configurations when the end of the separator sieves is a greater distance from the chopper housing than typically possible, in order to have the harvest residue include both the second material, which is primarily chaff, and the straw spread evenly over the field, the processed chaff is incorporated back into the straw near the straw spreading section and the combined material is spread over the field.

The methods for spreading the material described above work well while the WSD is engaged and processing the chaff, however on combines where the distance between the end of the sieve and entrance to the chopper is great, when it is not desirable to process the chaff through the WSD, such as an excess of stones in the field, not many weeds in the crop etc, there is currently no mechanism to propel the chaff into the tailboard spreader or otherwise to effect a spreading action of the chaff.

WSDs mounted on combines where the distance between the end of the sieves and chopper inlet is great, work well when the WSD in engaged but if the user does not want to use the WSD, currently there is no method to bypass the WSD and still be able to spread the chaff. In this case, the operator currently has only the options of removing the WSD, continuing to harvest with the WSD operating or to deposit the chaff directly behind the combine in a row on the ground. Removing the WSD and replacing it with a chaff spreader takes too much time and effort while continuing to operate the WSD could lead to damaged parts or further wear and operational costs without benefit, while depositing chaff in a row behind the harvester is not agronomically desirable as the nutrients in the chaff will not be distributed back onto the field and into the soil, and the heavy row of chaff would become detrimental to the growth of next years seeded crop.

To get optimal spreading performance, the chaff should be spread preferably by being integrated back into the straw stream and dispersed over the field. In this case, the heavier straw helps carry the lighter chaff a much greater distance than without incorporating with the straw. Some existing technology blows the chaff out sideways from the combine resulting in chaff spread distances that are less than the distance that the straw is spread. Also, if there is a side wind, the chaff will be blown back onto the combine where it can damage belt drives and pose a fire hazard if a bearing or other mechanical component would fail.

With existing technology on combines where the distance between the end of the sieves and the entrance to the straw chopper or spreader is great, when is performing a grain loss test, the chaff would be deposited directly behind the combine in a row on the ground. This again is not agronomically desirable as the nutrients in the chaff will not be uniformly distributed back onto the field and into the soil.

The object of the present invention is to effectively spread harvest residue on combines fitted with a weed seed destructor where the distance between the end of the sieves and chopper is great.

The invention thus provides a method to move chaff from the end of the sieves to the inlet of the tailboard spreader to be able to merge the unprocessed chaff stream and the straw stream together to ensure uniform spread distribution over the field.

The arrangement disclosed herein also utilizes simplified and cost reduced methods to increase spread velocity of the chaff while creating even distribution.

The weed seed destructor is provided on a combine harvester with the objective of providing components for devitalizing the weed seeds in the chaff so that they are unviable and do not germinate after the chaff is spread out on the field during harvesting. When a combine is fitted with a WSD, it is very important that the original functionality of the combine is not compromised.

In this invention, the WSD provides an improved spreading action and can be used to bridge the gap between the end of the sieves and the entrance to the tailboard spreader. The WSD is movable in such a way that in a first position, the chaff from the sieves is directed into the WSD. The chaff is processed and then discharged is from the exit of the WSD and optionally into the inlet of the tailboard spreader. When the operator desires to have the chaff bypass the WSD, the WSD is moved into a second position, which can be tilted rearward. A bypass device which can include a guide surface is then placed over the inlet of the WSD and the chaff exiting the sieves passes over the inlets of the WSD towards the rear of the WSD unit. In this position, the WSD rotor continues to rotate and propel air out of its outlets. This air can be deflected up and towards the inlet of the tailboard spreader in a manner that the chaff flowing on the WSD bypass panel is deposited in the steam of air generated by the WSD which can be carried into the inlet of the tailboard spreader. The bypass device can be formed as a reciprocating panel or sieve extension or any type of arrangement to move the chaff which therefore defines a guide surface to carry the material over the inlet or inlets to the air stream from the WSD.

Preferably there is provided a straw chopper into which the first material is fed before passing to the straw spreading device. Typically the straw chopper comprises a housing having an inlet across the combine harvester with a chopper rotor rotatable about an axis transverse to the combine which drives chopped straw to a discharge mouth feeding into the straw spreading device.

In this arrangement, in many cases the straw chopper is located at least partly behind the weed seed destructor section. However the arrangement herein can be used in constructions where the straw chopper is located forwardly of the end of the sieves as a component of the combine harvester rather than in a separate rear housing.

In one embodiment, preferably the separation system comprises a sieve where the inlet of the straw chopper is located approximately 3 ft from the rear edge of the sieve. This distance and elevation difference between the WSD inlet and chopper inlet prevent conventional arrangements from being used.

In one embodiment, preferably, in both the first and second arrangements, the second material fed to the straw spreading device bypasses the straw chopper and moves directly to the spreader section without passing through the housing and rotor of the chopper. preferably in this construction in both the first and second arrangements, the second material fed to the straw spreading device passes underneath the housing of the straw chopper.

In one embodiment, preferably the weed seed destructor section causes generation of an air flow which exits through the discharge mouth and the air flow is used in both the first and second arrangements to at least partly carry the material to the straw spreading device.

In one embodiment, preferably there is provided an air flow guide surface which is located adjacent the discharge mouth in the second arrangement to provide a required direction of flow. Preferably the airflow guide surface is able to direct at least some of the flow to the inlet of the straw spreader from both the first and second arrangements. Alternately in one embodiment an airflow guide surface is moved away from the discharge mouth in the first arrangement. Preferably the velocity of the air flow carries the second material into an entrance of the straw spreading device.

The arrangement herein is particularly preferred when an inlet to the straw chopper is located at a height above the sieve.

The arrangement herein is particularly preferred when an inlet of the straw chopper is located at least 3 feet rearwardly from a rear end of the straw walkers or rotor.

In order to assist in by-passing the WSD when not required, preferably the weed seed destructor section is moved to change the geometry of the system between the first and second arrangements. For example, the WSD can be pivoted to a different angle about an axis transverse to the combine harvester. In this arrangement preferably the weed seed destructor section includes a transverse drive shaft for driving the rotor and the axis transverse to the combine harvester coincides with a longitudinal axis of the drive shaft. Also preferably the drive shaft is driven by a pulley so that the pulley remains on the transverse axis as the weed seed destructor section is pivoted.

In one embodiment, preferably in the second arrangement there is provided a by-pass guide surface which carries the second material over the inlet mouth to by-pass the weed seed destructor section. In this arrangement preferably the by-pass guide surface is connected to a forwardly and rearwardly reciprocating component of the separating system for movement therewith. In this arrangement, preferably the by-pass guide surface in the first arrangement is removed from its position over the inlet mouth. Thus the guide surface can be mounted on the combine harvester for movement between two positions or it can be removed from the weed seed destructor section for separate storage.

In one embodiment, preferably there are provided side guide surfaces which converge the second material inwardly toward a center of the combine harvester onto the by-pass guide surface. Again the inlet guide surfaces directing the second material into the inlet mouth can be removed from the inlet mouth to allow placement of the guide surface. The inlet guide surfaces can be movable or are removed from the weed seed destructor section for separate storage.

As stated above, many different modalities for causing this devitalization are possible including grinding, crushing, impacting, radiation and chemical systems. In embodiments where the WSD generates an airstream, the airstream can be used in the second arrangement, where the material bypasses the WSD, to assist in the spreading action where the WSD is maintained in operation even though empty of the material. This is particularly effective in relation to the impact system which is known to generate a high speed air stream. In other embodiments where the modality generates a much reduced or non-existent air stream, the WSD can be shut off while it is being bypassed. In this case the guide surface or device causing the bypass can carry the material to a location for spreading or another air stream generating system can be provided. This is particularly suitable where the SWD uses direct energy such as radiation to effect at least part of the devitalization.

The arrangement here in can be used with spreaders which comprise a conventional tailboard with guide fins or with a powered rotor tailboard.

### BRIEF DESCRIPTION OF THE DRAWINGS

One embodiment of the invention will now be described in conjunction with the accompanying drawings in which:

FIG. 1 is a side elevational view of the back end of a combine harvester including a straw chopper, a straw spreader and an apparatus for destruction of weed seeds according to the present invention in a first position or arrangement of the components in which the straw is fed to the chopper and following straw spreader, and the chaff and weed seeds are fed to the WSD following which they are discharged to the straw spreader.

FIG. 2 is a side elevational view of the combine harvester of FIG. 1 in a second position or arrangement of the components in which the straw is fed to the chopper and following straw spreader, and the chaff and weed seeds by-pass the WSD and is then carried to the straw spreader.

FIG. 3 is an isometric view from the top and one side of the apparatus as shown in the position of FIG. 1.

FIG. 4 an isometric view from the top and one side of the apparatus in the position as shown in FIG. 2.

FIG. 5 is a top plan view of the apparatus in the position as shown in FIG. 1.

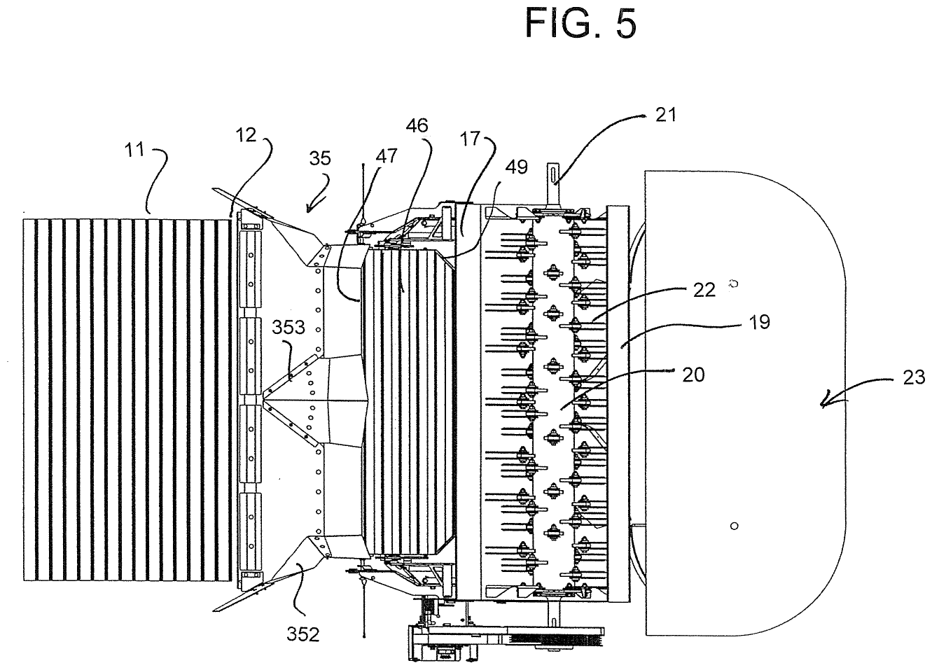

FIG. 6 is a bottom plan view of the apparatus in the position as shown in FIG. 1.

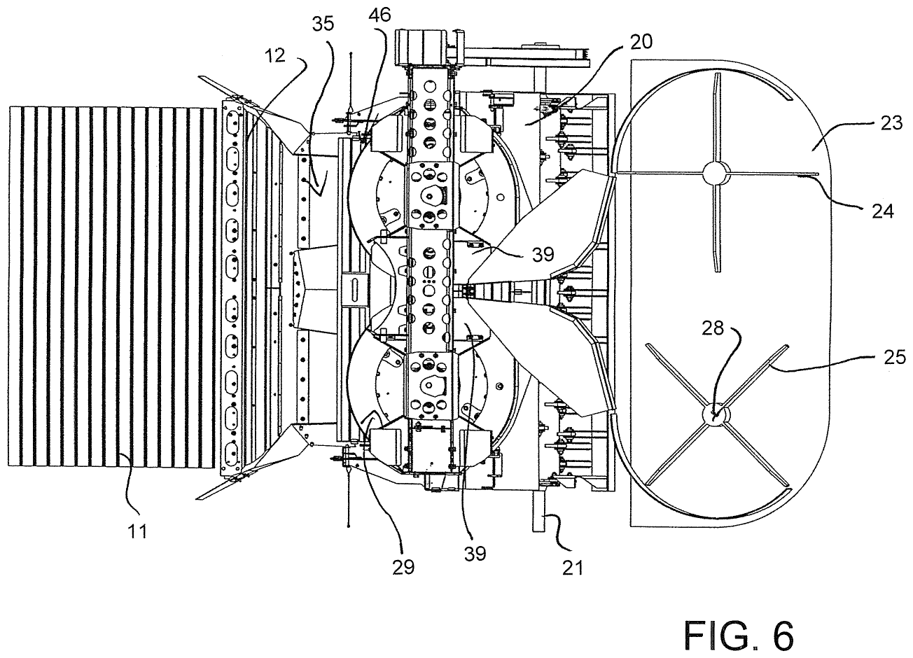

In the drawings like characters of reference indicate corresponding parts in the different figures.

### DETAILED DESCRIPTION

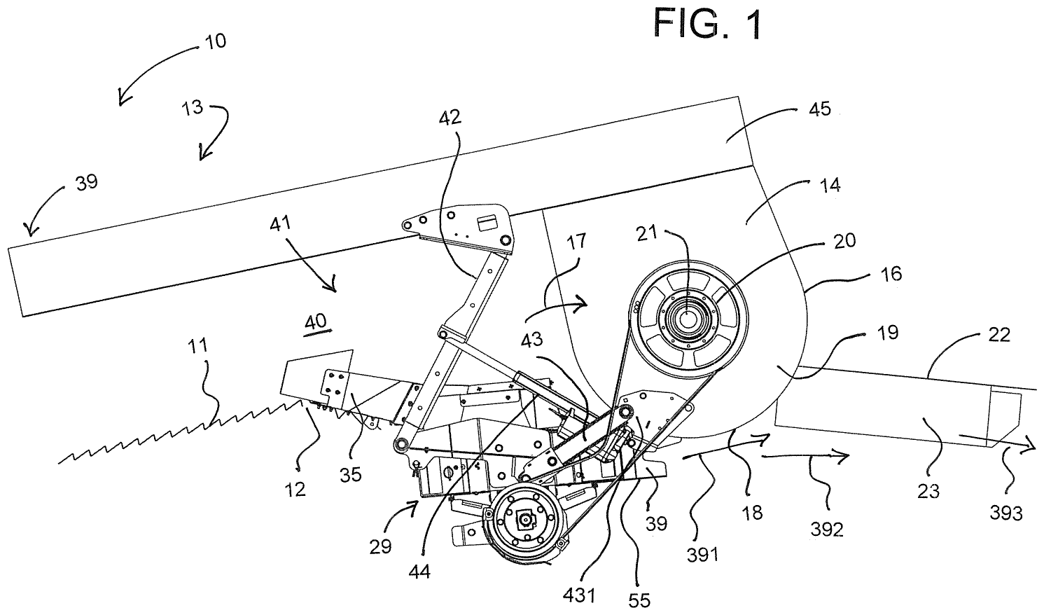

The apparatus herein is shown in FIG. 1 mounted on a combine harvester 10 carried on ground wheels and including harvesting components of a conventional nature the rearmost one of which is the sieve 11 which discharges chaff and discarded seeds including weed seeds to the rear edge 12 of the sieve.

A straw discharge arrangement 13 receives straw from a threshing rotor (not shown) and discharges separated straw to a chopper and discharge arrangement 14 shown in FIG. 1.

The chopper thus comprises a housing 16 defined by a top wall, a bottom wall and two end walls. The end walls include attachment means for attachment of the housing to the outlet hood of the combine harvester for discharge of straw from the combine harvester into an inlet opening 17 of the housing 16. The bottom wall 18 defines a semi-cylindrical portion extending from the inlet 17 to an outlet 19 through which chopped straw and air is discharged at relatively high velocity for spreading across the field in a wide spread pattern.

Within the housing is mounted a hub 20 which is carried on suitable bearings mounting a shaft 21 for rotation about a hub axis at a center of the housing 16 so that blade members 22 carried by the hub sweep around within the housing to entrap straw fed through the inlet 17 and to carry the straw and air past stationary is blades for chopping and for discharge through the outlet. The stationary blades are mounted on the housing at a position approximately midway between the inlet 17 and the outlet 19 so that the blade members sweep between the stationary blades in a cutting action.

At the exit is provided the material spreading assembly which can be the form of a tailboard with guide fins for receiving the chopped material and spreading the material to the rear and sides of the combine harvester.

However in the present arrangement the spreading device is preferably a powered spreader 23 with two generally rotors 24 and 26 carrying angularly spaced upstanding blades which rotate around generally upright axes 28. The rotors are driven from a transverse shaft (not shown) which carries a pulley driven by a belt which is driven by the rotor hub shaft 21.

In the Figures a weed seed destructor 29 includes two separate destructor elements 30, 31 side by side each including a housing 32 with a rotor 33 and a stator 34 formed by three stationary annular coaxial cylinders. The housing 32 causes the weed seeds to contact the stator 34 so that impacts between the stator and rotor thus devitalizing the seed. This arrangement is shown in detail in the above cited patents of the present applicant.

The destructors in this embodiment use multiple impacts to cause the necessary devitalization but, as a known alternative, other modalities use radiation applied to the seeds. This can simply be a source of electromagnetic radiation at a is determined intensity and spectrum and wavelength. The electromagnetic radiation applied to the seeds can be visible light. The electromagnetic radiation in the embodiment can includes heat and light which can be at a visible wavelength. However other modalities can be used including chemical materials.

In operation, flails of the rotor 33 act to draw chaff and weed seeds into each of the two side by side mills 30 and 31 through guide surfaces 35 forming generally a funnel 36 and accelerate and direct the material to impact and shear the material. The funnel 36 has an open top mouth and converges downwardly and inwardly to a circular inlet 37 above the rotor. The funnels meet at a center line or divider wall 38 so that the material including the chaff and weed seeds falls from the 12 of the sieve 11 and divides at the center into one or other of the two destructor mills 30, 31 to be devitalized as described in the above cited prior patents.

The guide surfaces 35 include two side guide surfaces 351 and 352 with includes surfaces over which the chaff from the rear edge 12 of the sieve passes to as to converge the material inwardly toward the center. A center guide 353 acts to divide the material from the rear edge into two paths each direct toward the opening 37 of the respective mill 30, 31.

The combine harvester thus comprises a separation system defined by the rotor or straw walkers (not shown) and the sieve 11 for separating from harvested crop a first material at a first discharge location schematically indicated at 39 at the rear comprising straw and a second material comprising chaff and weed seeds at a second discharge location 40 at the rear of the sieve 11.

The rotor or discharge beater (not shown) acts as a first material discharge section at the first discharge location 39 and operates to throw the separated first material containing or consisting of the separated straw rearward toward the straw spreader or chopper 14.

The straw spreading section 22 operates to receive the straw from the rotor and acts to spread the straw so that it is discharged to the rear and to the sides of the combine harvester in known manner.

As is conventional and well known, the sieve 11 has openings allowing passage of separation air from below to separate chaff and weed seeds from grain so that the grain falls through to a collection system below while the chaff and weed seeds remain above the sieves and are discharged rearwardly over the rear edge 12 either in a curtain as the material drops off the rear edge or as a stream in the air flow which is discharged through the sieves and moves upwardly and rearwardly away from the sieves as a stream.

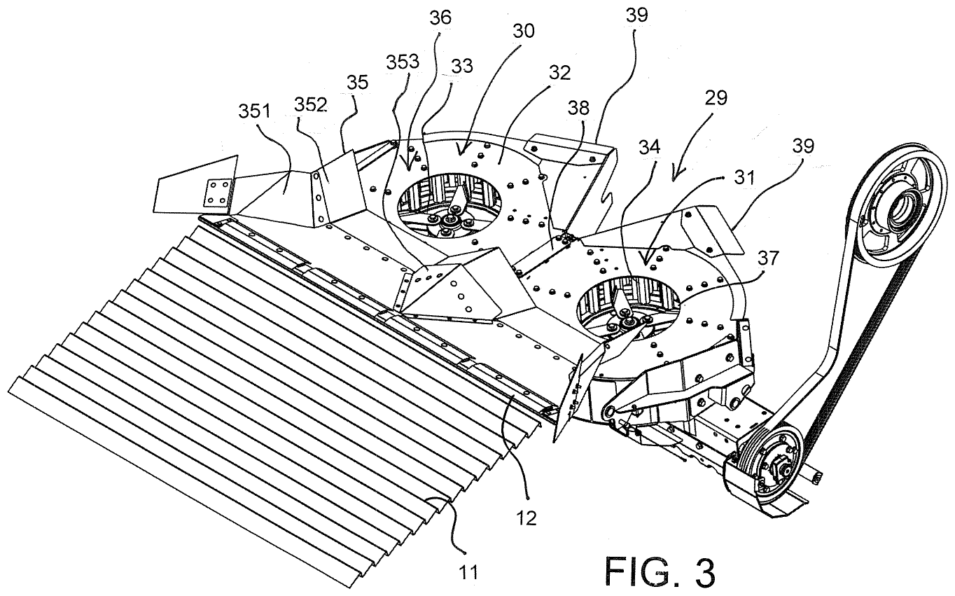

In the present invention as shown in FIGS. 1 and 3. the weed seed destructor section and the straw spreading device have a first arrangement or configuration in which the second material including the chaff and weed seeds is directed into the weed seed destructor section by the guide surfaces 35 defining the funnels 36 to the inlets 37 of the two rotors. The WSD includes two discharge mouths 39 located at or adjacent the inner edges of the two mills at a center line of the WSD directing material generally rearwardly but also slightly outwardly from the center line.

In this first arrangement of the WSD and the chopper and spreader as shown, the mouths 39 are arranged to direct the material along a path 391 from discharge mouth rearwardly underneath the bottom wall 18 of the housing 14 into or onto the underside of the straw spreading device 22.

Alternatively, the geometry of the mouths 39 can be arranged to discharge under the spreading device along a path 392 to combine with the straw as it is released or after it is released on a path 393 from the spreading device. In a further alternative, the mouths can be arranged to discharge to the sides of the combine in parallel with the discharged straw.

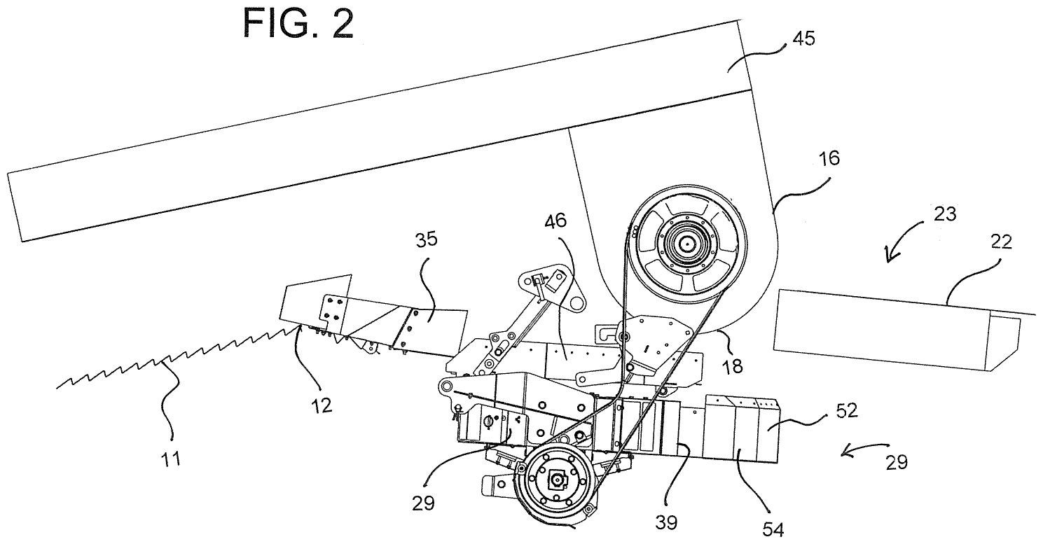

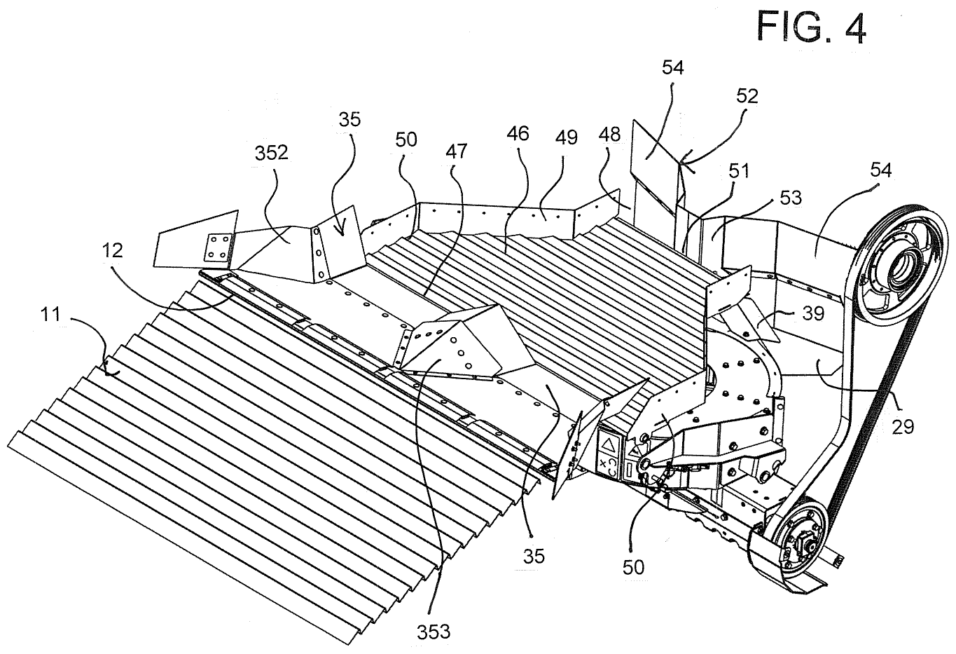

As shown in FIGS. 2 and 4, the weed seed destructor section and the straw spreading device have a second arrangement or configuration in which the chaff and weed seeds of the second material by-passes the weed seed destructor section 20. The configuration is obtained by moving the components as described hereinafter so that at least some of the second material by-passing the weed seed destructor section is directed to the straw spreading device 22, or into the discharged straw as it is released from the straw spreader 22, or to the sides in parallel with the discharged straw.

A seen by comparing FIGS. 1 and 2, the weed seed destructor 29 has two positions relative to the rear end 12 of the sieve and relative to the chopper 16. Thus the destructor 29 is mounted on a linkage 41 including two levers 42 and 43 and an actuator 44. The upper end of the lever 42 is carried on the hood or frame 45 of the combine harvester which carries the chopper 14. The lower end of the lever carries the forward end of the housing of the destructor. The lever 43 is connected between the forward end of the destructor and a bracket 431 mounted on the lower part of the chopper housing. The actuator 44 acts to pull the lever 42 and thus the destructor rearwardly to the position shown in FIG. 2. In FIG. 1, in the first position, the discharge mouths 39 of the destructor 3 are moved close to the bottom wall 18 of the chopper 14 so that the discharge streams from the mouths carrying the chaff pass underneath the bottom wall toward the rotating spreader fans 23 on the tailboard. The material can be directed into the spreader, or below the spreader to join the straw as it leaves the spreader. The arrangement may also direct the chaff outward to the sides so that the chaff joins the straw stream during its spreading movement outward to the sides.

In order to assist the movement of the material which has by-passed the WSD, there can be provided a nozzle or an air flow guide surface 55 which is located adjacent the discharge mouth to guide the air flow up above the WSD to entrain the material passing over the WSD. The nozzle 55 can be adjusted or moved away from the discharge mouth in the second arrangement. The nozzle 55 can be shaped so that the velocity of the air flow carries the second material into an entrance of the straw spreading device. Alternately the nozzle can be directed to the discharged straw, or to the sides of the combine.

In FIG. 3, therefore in the forward first position of the destructor, the chaff from the rear end of the sieves is directed by the guides 35 into the open inlets of the destructor.

Thus, as shown in FIG. 1, the straw chopper 14 is located at least is partly behind and partly above the weed seed destructor section 29 allowing the discharged material from the WSD to move under the chopper housing 14 to the spreader 22.

As shown in FIGS. 2 and 4, an addition guide surface 46 is provided which has a front edge 47 at the rear of the guide 35 so that in this position the chaff is carried onto the guide surface 46 and thus moves over the guide surface to a rear edge 48 from which it is discharged in a stream falling from the rear edge.

The guide surface 46 has an upstanding guide wall 49 at the rear edge which converges inwardly from outer side edges 50 aligned with the rear edge of the guide 35. Thus the guide wall 49 carries the chaff inwardly and rearwardly to a discharge edge 51 at the rear which is narrower than the front edge. In this way the chaff is converged so that when it falls the width of the stream matches the width of or spacing between the discharge mouths so that the falling stream of chaff drops into the rearwardly directed air stream from the mouths 39. Of course in this arrangement the destructor mills remain driven to generate the air stream even though there is no inlet material which is by-passed. The mills can be run without risk of damage from stones and the like as the material is by-passed. Also a reduction in power requirement is obtained.

Behind the discharge mouths 39 is provided an upstanding guide wall 52 which diverges rearwardly and outwardly from a center apex facing the rear edge 51 of the guide surface 46 to a pair of outer wings 54. These are used, if required, to is guide the high speed stream of air from the mouths 39 outwardly and rearwardly so that the stream of air does not enter the spreader 23 but instead generates a parallel stream in front of the stream from the spreader. In this way the high speed air from the mouths does not disturb the straw residue flow into the rotary spreaders but instead enhances it by forming the parallel stream which tends to join the straw at a position outward from the spreader. This parallel stream is synergistic in that enhances the straw stream while feeding the chaff into the stream of straw so that the chaff which is very light joins with the heavier stream of straw so as to be carried further outwardly. This arrangement thus improves both the straw spreading action and the chaff spreading action.

In other arrangements, particularly where a tail board with guide fins is used as the spreader, the chaff in the airstream can be directed into the tailboard to join with the straw on the tailboard or at the outer edge of the tailboard to join with the straw as it exits the tailboard. Thus no guide wall corresponding to wall 52 is used or the shape can be modified to direct the chaff to the required location.

The guide surface 46 including the wall 49 can be mounted so that both reciprocate with the sieve to help carry the material to the rear edge. The use of a corrugated surface with transverse ribs as shown assists with the rearward movement of the chaff as the corrugated surface reciprocates back and forth.

The guide surface 46 with the upstanding rear wall can be mounted in the second position on suitable coupling elements (not shown) and then removed from the structure in the first position for separate storage. Alternatively, the components can be mounted on a suitable pivot arrangement which allows the surface and wall to the pivoted upwardly in the first position to stand upwardly at a suitable location along the front of the chopper housing while of course not interfering with the inlet of the straw into the chopper. Suitable linkages are not shown but it will be appreciated that such linkages can be designed to provide the functions required while fitting the geometry.

As shown in FIGS. 1 and 2, in both the first and second arrangements, the second material including the chaff which is fed to the straw spreading device or to join with the straw from the straw spreading device bypasses the straw chopper in that it is not fed into the straw chopper. In FIG. 1, the discharge mouths are arranged to generate the stream containing the material so that it is carried by the stream to mix with the straw for combined spreading. In FIG. 2, the material by-passing the WSD is carried again underneath the housing of the chopper to join with the straw from the spreader.

In the second configuration of FIG. 2, the weed seed destructor section continues to run with no material passing through and this acts to cause generation of an air flow which exits through the same discharge mouth without the entrained material and the air flow is used in the second arrangements to carry the material to the straw spreading device, the discharged straw, or to the sides.

Alternately, if other modes are used to kill the weeds which do not generate an air stream at all or when no material is fed into the system, the WSD can be turned off, as it is not require d and not effective to cause or assist the spreading action, with the transfer method still running to convey the chaff residue to a spreading system, typically the the straw spreading device.

The weed seed destructor section 29 can be translated rearwardly and downwardly as shown on a linkage or it can be pivoted into the by-pass position in the clockwise direction to a different angle about an axis transverse to the combine harvester. In some cases, this can be conveniently done by pivoting the weed seed destructor section includes a transverse drive shaft carrying a drive input pulley for driving the rotors and the axis transverse about which the WSD pivot coincides with a longitudinal axis of the drive shaft. In this way the pulley remains on the transverse axis as the weed seed destructor section is pivoted.

Thus in the second arrangement, there is provided a by-pass device such as a guide surface 46 in the form of a flat or corrugated sheet which is laid over the inlets to the WSD housing and carries the second material over the inlet mouth to by-pass the weed seed destructor section. The sheet covers the mouths and extends from a front edge just behind the rear edge of the sieve to a rear edge at the nozzle 55. The sheet has a width sufficient to cover the WSD and to ensure that all of the second material is carried in a sliding action to the rear edge to be discharged and carried to the common spreading position. Alternately any mechanism that can be utilized to convey the second material past the WSD housing could be used.

In order to assist in the movement of the crop over the sheet and to prevent hang-ups the sheet can be attached to the reciprocating movement of the sieve and carried on a pivotal support 66. In addition, side guide surfaces 62 are is provided attached also the sieve at the sides of the rear end of the sieve which converge the second material inwardly toward a center of the combine harvester onto the by-pass guide surface 59, bearing in mind that the WSD and the air stream therefrom are both narrower than the rear edge of the sieve.

As shown in FIG. 1, the by-pass guide surface in the first arrangement is removed from its position over said at least one inlet mouth and can be moved to a different location for separate storage.

In the second position, the rear portion of the inlet guide surfaces or funnels 30 directing the second material into the inlet mouths can be removed or reconfigured or moved on a linkage arrangement to allow the chaff to flow off the rear of the WSD and allow the airflow from the WSD to move the chaff to the inlet of the straw spreader.

1. A combine harvester comprising:
a separation system for separating from harvested crop a first material comprising straw and a second material comprising chaff and weed seeds;
a straw spreading device for receiving the first material and spreading the first material at least to the sides of the combine harvester;
a weed seed destructor section arranged to receive the second material;
the weed seed destructor section having one or more components acting on the weed seeds in the second material so as to cause devitalization of at least some of the weed seeds so that they cannot germinate;
the weed seed destructor section having at least one discharge mouth for discharge of the second material after said devitalization;
wherein the weed seed destructor section causes generation of an air flow which exits through said at least one discharge mouth;
the weed seed destructor section and the straw spreading device being operable in a first arrangement in which:
the first material is directed to the straw spreading device for spreading the first material at least to the sides of the combine harvester;
and the second material is directed into the weed seed destructor section and at least some of the discharge from said at least one discharge mouth is spread in said airflow at least to the sides of the combine harvester;
the weed seed destructor section and the straw spreading device being operable in a second arrangement in which:
the first material is directed to the straw spreading device for spreading the first material at least to the sides of the combine harvester;
and the second material by-passes the weed seed destructor section and at least some of the second material by-passing the weed seed destructor section is spread at least to the sides of the combine harvester;
wherein the air flow from said at least one discharge mouth is used in the second arrangement to carry said second material for spreading at least to the sides of the combine harvester.

2. The combine harvester according to claim 1 wherein, in the second arrangement, the air flow through said at least one discharge mouth is used to transfer said second material to said straw spreading device.

3. The combine harvester according to claim 1 wherein, in the second arrangement, the air flow through said at least one discharge mouth directed outwardly to the sides to spread the second material at least to the sides of the combine harvester.

4. The combine harvester according to claim 3 wherein, in the second arrangement, the air flow through said at least one discharge mouth is used zo to carry the second material for combining with the first material as it is spread at least to the sides of the combine harvester by the straw spreading device.

5. The combine harvester according to claim 1 wherein there is provided a straw chopper having a housing containing a rotor into which the first material is fed before passing to the straw spreading device.

6. The combine harvester according to claim 5 wherein, in both the first and second arrangements, the second material bypasses the straw chopper.

7. The combine harvester according to claim 5 wherein the separation system comprises a sieve and wherein an inlet of the straw chopper is located at least 3 feet rearwardly from a rear edge of the sieve.

8. The combine harvester according to claim 5 wherein the separation system comprises a sieve and wherein an inlet to the straw chopper is located at a height above the sieve.

9. The combine harvester according to claim 5 wherein the separation system includes a threshing section including straw walkers or a short length rotor so that an inlet of the straw chopper is located at least 3 feet rearwardly from a rear end of the straw walkers or rotor.

10. The combine harvester according to claim 1 wherein at least in the second arrangements the second material carried by the airflow from said at least one discharge mouth is directed onto an upstanding guide wall which directs the second material at least partly outwardly to the sides of the combine harvester.

11. The combine harvester according to claim 10 wherein the air flow is arranged in the second arrangement to carry the second material outwardly to the sides in front of the straw spreading device so as to combine the second material with the straw from the straw spreading device as it is being spread to the sides.

12. The combine harvester according to claim 1 wherein there is provided an air flow guide surface forming a nozzle which is located adjacent said at least one discharge mouth in the second arrangement and is moved away from said at least one discharge mouth in the first arrangement.

13. The combine harvester according to claim 1 wherein the weed seed destructor section is moved relative to the straw spreader between the first and second arrangements.

14. The combine harvester according to claim 13 wherein the weed seed destructor section is moved downwardly and rearwardly between the first and second arrangements.

15. The combine harvester according to claim 1 wherein the weed seed destructor section includes at least one inlet mouth and in the second arrangement there is provided a by-pass device having a guide surface which carries the second material over said at least one inlet mouth to by-pass the weed seed destructor section.

16. The combine harvester according to claim 15 wherein the bypass device is connected to a forwardly and rearwardly reciprocating component of zo the separating system for movement therewith.

17. The combine harvester according to claim 15 wherein the bypass device in the first arrangement is removed from its position over said at least one inlet mouth.

18. The combine harvester according to claim 15 wherein the bypass device is repositioned or removed from the weed seed destructor section for separate storage.

19. The combine harvester according to claim 15 wherein the bypass device includes upstanding side guide wall surfaces which converge the second material inwardly toward a center of the combine harvester.

20. A combine harvester comprising:
a separation system for separating from harvested crop a first material comprising straw and a second material comprising chaff and weed seeds;
a straw chopping device for receiving and chopping the first material and a straw spreading device for receiving the chopped first material and spreading the is first material at least to the sides of the combine harvester;
a weed seed destructor section arranged to receive the second material;
the weed seed destructor section having one or more components acting on the weed seeds in the second material so as to cause devitalization of at least some of the weed seeds so that they cannot germinate;
the weed seed destructor section having at least one discharge outlet for discharge of the second material after said devitalization;
the weed seed destructor section and the straw spreading device being operable in a first arrangement in which:
the first material is directed to the straw spreading device for spreading the first material in a discharge stream at least to the sides of the combine harvester;
and the second material is directed into the weed seed destructor section and at least some of the discharge from said at least one discharge mouth is spread in a discharge stream at least to the sides of the combine harvester;
the weed seed destructor section and the straw spreading device being operable in a second arrangement in which:
the first material is directed to the straw spreading device for spreading the first material in a discharge stream at least to the sides of the combine harvester;
and the second material by-passes the weed seed destructor section and at least some of the second material by-passing the weed seed destructor section is spread in a discharge stream at least to the sides of the combine harvester;
wherein, in both the first and second arrangements, the second material bypasses the straw chopping device.

21. The harvester as in claim 20, wherein the weed seed destructor section is turned off while the second material bypasses the weed seed destruction section.
